(19) United States
(12) Patent Application Publication
(10) Pub. No.: US 2026/0330881 A1
(43) Pub. Date: Oct. 22, 2026

(54) PROCESSING APPARATUS

(71) Applicant: NEC Solution Innovators, Ltd., Koto-ku, Tokyo (JP)

(72) Inventor: Kazuhide UMEDA, Tokyo (JP)

(73) Assignee: NEC Solution Innovators, Ltd., Koto-ku, Tokyo (JP)

(21) Appl. No.: 19/112,283

(22) PCT Filed: Sep. 22, 2023
(86) PCT No.: PCT/JP2023/034539

§ 371 Date: Mar. 17, 2025

(30) Foreign Application Priority Data
Oct. 5, 2022 (JP) 2022-161038

(51) Int. Cl. G06V 40/50

(52) U.S. Cl. CPC G06V 40/50

(57) ABSTRACT

A processing apparatus includes: a storing unit that stores a false authentication score, which is a score calculated when it is determined that false authentication has occurred in face authentication, into a storage device; and an adjusting unit that adjusts a value used when face authentication is performed based on the false authentication score.

### TECHNICAL FIELD

The present invention relates to a processing apparatus, a processing method, and a recording medium.

### BACKGROUND ART

It is known to use biometric information such as facial features to achieve various objects such as face authentication.

For example, Patent Literature 1 describes a face authentication apparatus that includes a face image acquiring unit acquiring a face image of an authentication target, a matching unit performing face authentication based on a threshold value on the face image of the authentication target, a time measuring unit measuring an elapsed time from the start of operation of the face authentication apparatus, and a threshold value changing unit restricting change of the threshold value to a value greater than a value determined in dependence on the measured elapsed time.

### CITATION LIST

Patent literature 1: Japanese Unexamined Patent Application Publication No. JP-A 2019-125003

### SUMMARY OF INVENTION

### Technical Problem

Depending on the installation environment of a camera acquiring a face image, a proper threshold value used for face authentication may vary. In order to cope with such a variation, it may not necessarily be appropriate to simply adjust the threshold value in accordance with a lapse of time as described in Patent Literature 1. Thus, there has been a problem that it may be difficult to properly adjust a value used for face authentication.

Accordingly, an object of the present invention is to provide a processing apparatus, a processing method, and a recording medium that aim to solve the abovementioned problem.

### Solution to Problem

In order to achieve the object, a processing apparatus as an aspect of the present disclosure includes: a storing unit that stores a false authentication score, which is a score calculated when it is determined that false authentication has occurred in face authentication, into a storage device; and an adjusting unit that adjusts a value used when face authentication is performed based on the false authentication score.

Further, a processing method as another aspect of the present disclosure includes: storing a false authentication score, which is a score calculated when it is determined that false authentication has occurred in face authentication, into a storage device; and adjusting a value used when face authentication is performed based on the false authentication score.

Further, a recording medium as another aspect of the present disclosure is a non-transitory computer-readable recording medium having a program recorded thereon, and the program includes instructions to realize processes to: store a false authentication score, which is a score calculated when it is determined that false authentication has occurred in face authentication, into a storage device; and adjust a value used when face authentication is performed based on the false authentication score.

### Advantageous Effects of Invention

With the configurations as described above, it is possible to solve the abovementioned problem.

### BRIEF DESCRIPTION OF DRAWINGS

FIG. 1 is a diagram showing an example of a configuration of an authentication system in a first example embodiment of the present disclosure.

FIG. 2 is a block diagram showing an example of a configuration of an authentication apparatus.

FIG. 3 is a diagram showing an example of an authentication process.

FIG. 4 is a diagram showing an example of an authentication process.

FIG. 5 is a diagram for describing an example of threshold value adjustment.

FIG. 6 is a diagram for describing an example of threshold value adjustment.

FIG. 7 is a diagram for describing an example of threshold value adjustment.

FIG. 8 is a diagram for describing an example of threshold value adjustment.

FIG. 9 is a flowchart showing an example of operation at the time of score storage.

FIG. 10 is a flowchart showing an example of operation at the time of threshold value adjustment.

FIG. 11 is a flowchart showing an example of operation at the time of confirmation omission determination.

FIG. 12 is a block diagram showing an example of a configuration of a processing apparatus in a second example embodiment of the present disclosure.

FIG. 13 is a block diagram showing an example of a configuration of the processing apparatus.

### EXAMPLE EMBODIMENT

### First Example Embodiment

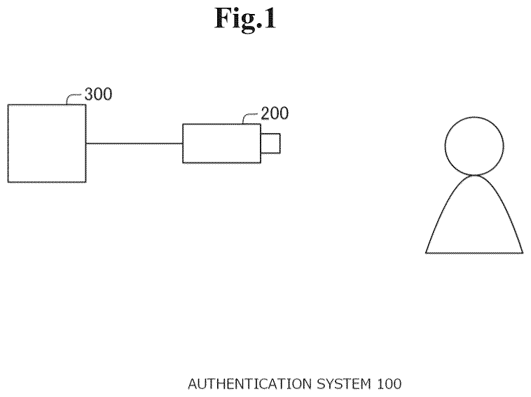

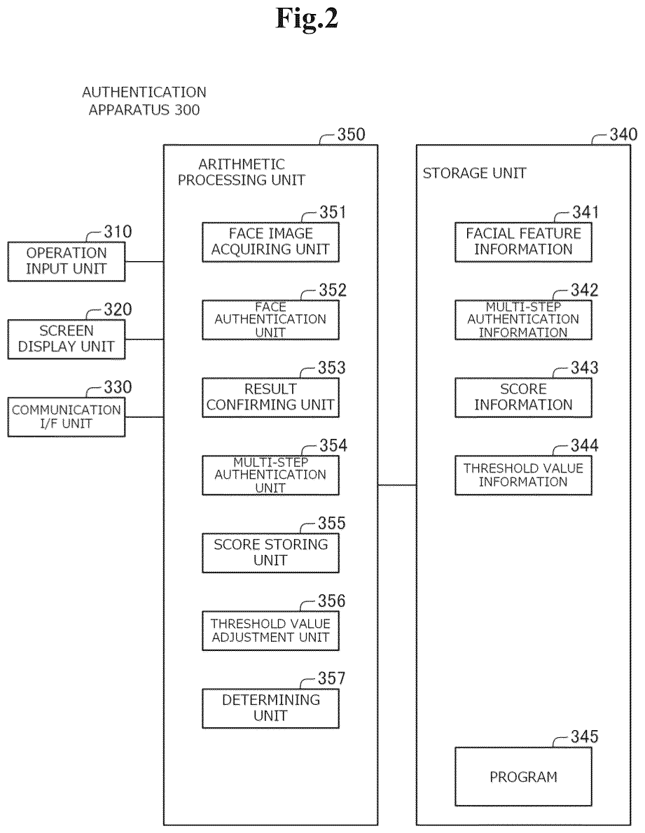

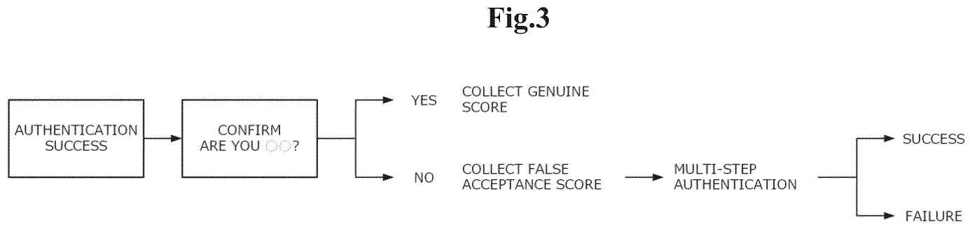

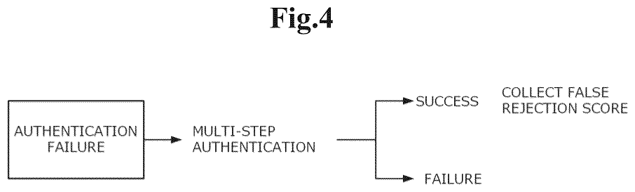

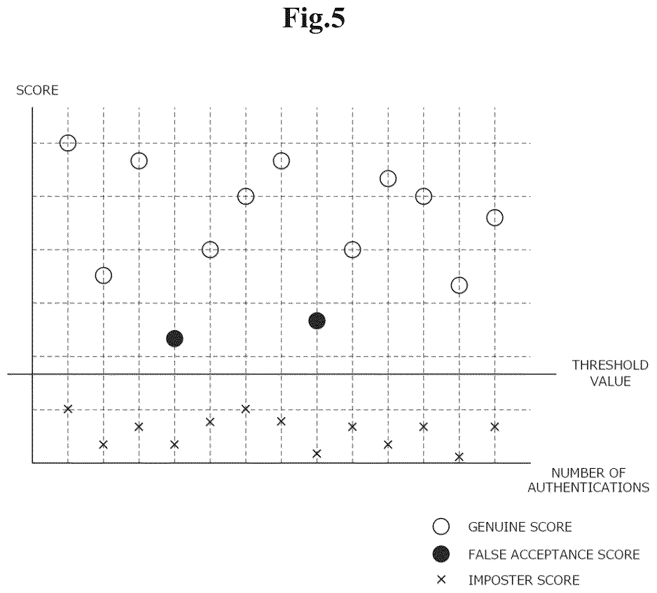

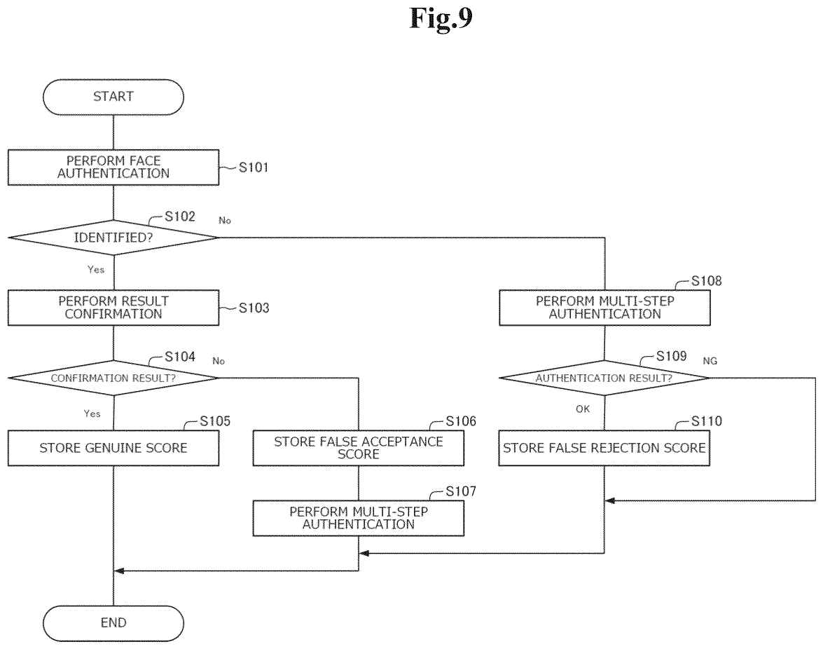

A first example embodiment of the present disclosure will be described with reference to FIGS. 1 to 11. FIG. 1 is a diagram showing an example of a configuration of an authentication system 100. FIG. 2 is a block diagram showing an example of a configuration of an authentication apparatus 300. FIGS. 3 and 4 are diagrams showing an example of an authentication process. FIGS. 5 to 8 are diagrams for describing an example of threshold value adjustment. FIGS. 9 to 11 are flowcharts showing an example of operation of the authentication apparatus 300.

In the first example embodiment of the present disclosure, the authentication system 100 will be described that performs face authentication based on a face image of an authentication target person who is the user of the authentication system 100 and that can adjust a value used for face authentication by analyzing the result of authentication. As will be described later, in the authentication system 100 described in this example embodiment, when it is determined that a false authentication has occurred, a false authentication score that is a score at the time of the false authentication is collected. Then, the authentication system 100 adjusts a threshold value used for authentication based on the collected false authentication score.

In this example embodiment, the false authentication score includes a score at the time of a false authentication based on a face image of another person, a score at the time of a failure in authentication of a person who should be authenticated, and the like. For example, the false authentication score includes a false acceptance score that is a score calculated based on a face image of another person that the authentication system 100 has incorrectly determined to be an authentication target person at the time of the false authentication based on the face image of the other person stored in advance in the authentication system 100. Moreover, the false authentication score includes a false rejection score that is a score assumed that there is a possibility of an authentication target person, such as the highest score of scores that the authentication system 100 has calculated when failing in authentication of the authentication target person whose face image is to be stored in the authentication system 100. For example, the authentication system 100 can determine the false authentication as described above by confirming the authentication result or performing multi-step authentication as will be described later. In a case where an authentication target person can be identified by multi-step authentication or the like, the false rejection score may be a score calculated by the authentication system 100 with an already stored face image corresponding to the identified authentication target person among the scores calculated by the authentication system 100.

Further, in this example embodiment, a score is a value calculated by the authentication system 100 at the time of face authentication. For example, the score is the degree of similarity between a feature extracted from a face image of a user using the authentication system 100 and a feature extracted from a face image stored in advance in the authentication system 100. The extraction of the feature may be performed by a known method, such as calculation based on the result of detection of a facial feature point in a detected face region. The degree of similarity may be a value calculated using a known method such as the degree of cosine similarity.

FIG. 1 shows an example of a configuration of an authentication system 100. Referring to FIG. 1, the authentication system 100 includes, for example, an imaging device 200 such as a camera and an authentication apparatus 300 that performs face authentication. As shown in FIG. 1, the imaging device 200 and the authentication apparatus 300 are connected via a network or the like in such a manner as to be communicable with each other. The authentication system 100 may have a configuration other than that illustrated in FIG. 1, such as having a plurality of imaging devices 200, for example.

The imaging device 200 acquires a face image of a user, an authentication target person and the like of the authentication system 100. For example, the imaging device 200 may be a general device such as a camera. Moreover, the imaging device 200 can transmit the acquired face image to the authentication apparatus 300. The imaging device 200 may transmit the acquired face image to the authentication apparatus 300 together with identification information determined in advance for each imaging device 200, information indicating the time of acquisition of the face image, and the like.

The authentication apparatus 300 is an information processing apparatus that performs face authentication based on a face image of an authentication target person acquired by the imaging device 200. Moreover, in a case where it is determined that a false authentication has occurred in accordance with the result of confirmation of the authentication result by the authentication target person or the result of multi-step authentication, the authentication apparatus 300 collects a false authentication score corresponding to the type of the false authentication. Then, the authentication apparatus 300 adjusts a value used for authentication based on the collected false authentication score and the like.

FIG. 2 shows a major example of a configuration of the authentication apparatus 300. Referring to FIG. 2, the authentication apparatus 300 includes, as main components, an operation input unit 310, a screen display unit 320, a communication I/F unit 330, a storage unit 340, and an arithmetic processing unit 350, for example.

FIG. 2 illustrates a case of implementing a function as the authentication apparatus 300 using a single information processing apparatus. However, the authentication apparatus 300 may be implemented using a plurality of information processing apparatuses, such as being implemented on the cloud, for example. For example, the authentication apparatus 300 may include an authentication device having a face image acquiring unit 351, a face authentication unit 352, a result confirming unit 353, a multi-step authentication unit 354, and a score storing unit 355, and an analysis device having a threshold value adjustment unit 356, and a determining unit 357, of the functions illustrated in FIG. 2. Moreover, the authentication apparatus 300 may not have part of the configuration illustrated above, such as not having the operation input unit 310, or may have a configuration other than the configuration illustrated above.

The operation input unit 310 includes operation input devices such as a keyboard and a mouse. The operation input unit 310 detects an operation by a person who operates the authentication apparatus 300 and outputs to the arithmetic processing unit 350.

The screen display unit 320 includes a screen display device such as an LCD (liquid crystal display) or a display device with a touchscreen. The screen display unit 320 can display on a screen various information stored in the storage unit 340, information when the result confirming unit 353 to be described later performs predetermined result confirmation, and the like, in accordance with an instruction from the arithmetic processing unit 350.

The communication I/F unit 330 includes a data communication circuit. The communication I/F unit 330 performs data communication with the imaging device 200 and other external devices connected via the communication line.

The storage unit 340 is a storage device such as a hard disk or memory. The storage unit 340 stores processing information and a program 345 necessary for various processing by the arithmetic processing unit 350. The program 345 is loaded and executed the arithmetic processing unit 350 and thereby realizes various processing units. The program 345 is loaded in advance from an external device or a recording medium via a data input/output function such as the communication I/F unit 330, and stored in the storage unit 340. Main information stored in the storage unit 340 includes, for example, facial feature information 341, multi-step authentication information 342, score information 343, threshold value information 344, and so forth.

The facial feature information 341 includes information on a face image or a feature extracted from a face image used for face authentication. For example, in the facial feature information 341, a face image (stored face image) of the user of the authentication system 100 and each user's information such as name and department are associated with each other. The facial feature information 341 may include information indicating a facial feature extracted from a face image, instead of or together with the face image. As an example, the facial feature information 341 is acquired in advance in accordance with acquisition of a face image from an external device, the imaging device 200 or the like via the communication I/F unit 330, and stored in the storage unit 340. The facial feature information 341 may be updated as necessary in accordance with, for example, acquisition of a face image from an external device, the imaging device 200, and the like via the communication I/F unit 330.

The multi-step authentication information 342 includes information used when performing multi-step authentication. For example, the multi-step authentication information 342 includes encrypted information used at the time of multi-step authentication. Here, the encrypted information may be information for confirmation determined in advance in order to perform multi-step authentication, such as a value corresponding to the phone number of a company or the like to which the user of the authentication system 100 belongs, information corresponding to the name and employee number of the user or the like, and any other passcodes. For example, the multi-step authentication information 342 includes encrypted information for each user using the authentication system 100. The multi-step authentication information 342 may include encrypted information common to the users. As an example, the multi-step authentication information 342 is acquired in advance in accordance with, for example, acquiring it from an external device or the like via the communication I/F unit 330 or performing input using the operation input unit 310, and stored in the storage unit 340. The multi-step authentication information 342 may be updated as necessary in accordance with acquisition from an external device via the communication I/F unit 330.

The score information 343 includes information on the score calculated at the time of face authentication by the authentication apparatus 300. For example, the score information 343 includes a false authentication score such as a false acceptance score and a false rejection score described above in addition to a genuine user score that is a score at the time of successful face authentication. The score information 343 may include, in addition to the scores illustrated above, a non-genuine user score that is a score other than the genuine user score and the false authentication score calculated at the time of face authentication. The non-genuine user score falls under a score that does not correspond to a false rejection score among the scores determined by the authentication apparatus 300 to be another person at the time of face authentication. For example, the score information 343 includes information such as a genuine user score, a false authentication score and so forth for each face authentication. The score information 343 may include information such as a genuine user score or a false authentication score for each user using the authentication system 100. In addition, the score information 343 may include various scores for each imaging device 200, each time period, each season, and the like. As an example, the score information 343 is updated when the score storing unit 355 stores a genuine user score, a false authentication score and the like into the storage unit 340.

The threshold value information 344 includes information on a threshold value used at the time of face authentication. For example, the threshold value information 344 can include information on a threshold value for each user using the authentication system 100. The threshold value information 344 may include information indicating a threshold value for each imaging device 200 or each time period in which face authentication is performed. For example, the threshold value information 344 is acquired in advance in accordance with, for example, acquiring it from an external device or the like via the communication I/F unit 330 or performing input using the operation input unit 310, and stored in the storage unit 340. Moreover, the threshold value information 344 is updated based on the false authentication score and the like included in the score information 343 by the threshold value adjustment unit 356, which will be described later.

The arithmetic processing unit 350 includes a processor such as a CPU (Central Processing Unit) and a peripheral circuit thereof. The arithmetic processing unit 350 reads the program 345 from the storage unit 340 and executes it, thereby causing the above hardware and the program 345 to cooperate and realizing various processing units. Main processing units realized by the arithmetic processing unit 350 include, for example, the face image acquiring unit 351, the face authentication unit 352, the result confirming unit 353, the multi-step result confirming unit 354, the score storing unit 355, the threshold value adjustment unit 356, and the determining unit 357.

The arithmetic processing unit 350 may have a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The face image acquiring unit 351 acquires a face image of an authentication target person subject to face authentication. For example, the face image acquiring unit 351 acquires a face image of an authentication target person from the imaging device 200 via the communication I/F unit 330.

The face authentication unit 352 performs a face authentication process to confirm whether a face image of a person matching the person in the face image acquired by the imaging device 200 is stored in the storage unit 340 based on the facial feature information 341 and the threshold value information 344.

For example, the face authentication unit 352 calculates a score such as the degree of similarity between each of the stored face images included in the facial feature information 341 and a face image of an authentication target person acquired by the face image acquiring unit 351, and determines a combination with the highest score of face image and stored face image. The face authentication unit 352 may determine a plurality of combinations in which the score is equal to or more than a predetermined value. Moreover, the face authentication unit 352 determines a threshold value of a user corresponding to the stored face image in the determined combination with reference to the threshold value information 344. Then, the face authentication unit 352 compares the calculated score in the determined combination with the determined threshold value. For example, in a case where the score is equal to or more than the threshold value, the face authentication unit 352 generates an authentication result of face authentication success. On the other hand, in a case where the score is less than the threshold value, the face authentication unit 352 generates an authentication result of face authentication failure.

For example, as described above, the face authentication unit 352 performs the authentication process to confirm whether a face image of a person matching the person in the face image acquired by the imaging device 200 is stored in the storage unit 340. In addition, in a case where the authentication apparatus 300 can identify who an authentication target person is in advance by reading the employee ID of the authentication target person, the face authentication unit 352 may determine a threshold value corresponding to the user identified by the above means from the threshold value information 344. In this case, the face authentication unit 352 may determine whether the face authentication is successful based on the result of comparison between the threshold value determined by the above means and the highest score.

The result confirming unit 353 confirms with the authentication target person whether there is an error in the authentication by the face authentication unit 352 by displaying the result of the authentication by the face authentication unit 352 on the screen display unit 320. In other words, the result confirming unit 353 functions as a confirming unit to confirm whether a false authentication has occurred by performing confirmation of the authentication result with the authentication target person, which is a process different from the face authentication.

For example, the result confirming unit 353 confirms the authentication result when the face authentication unit 352 generates an authentication result of face authentication success. To be specific, for example, the result confirming unit 353 confirms with the authentication target person whether the authentication target person whose face image has been acquired by the imaging device 200 and the user corresponding to the stored face image used when calculating the score determined as authentication success are definitely the same person. As an example, the result confirming unit 353 can confirm whether the authentication target person is the identified user by displaying a name or the like associated with the stored face image on the screen display unit 320, such as “Are you XX?”.

In a case where it can be confirmed that there is nothing wrong by confirmation by the result confirming unit 353, the result confirming unit 353 can determine the omission of multi-step authentication. In this case, the authentication apparatus 300 may end the authentication process and, for example, start a predetermined process such as opening an associated door. On the other hand, in a case where it is confirmed that the authentication target person is different from the identified user by the confirmation by the result confirming unit 353, the result confirming unit 353 determines that a false authentication based on another person's face image has been performed. Further, the result confirming unit 353 determines to perform multi-step authentication. In addition, the result confirming unit 353 may be configured to, in the case of confirming that the authentication target person and the identified user are different, receive input of information indicating who the authentication target person is from the authentication target person.

The result confirming unit 353 may be configured to confirm even if the face authentication unit 352 generates an authentication result of face authentication failure. Further, as will be described later, in a case where the determining unit 357 determines that a predetermined condition is satisfied, the confirmation by the result confirming unit 353 can be omitted.

The multi-step authentication unit 354 performs multi-step authentication by receiving input of encrypted information such as a passcode using the operation input unit 310 or the like from an authentication target person. For example, the multi-step authentication unit 354 performs multi-step authentication when the result confirming unit 353 determines that a false authentication based on another person's face image has been performed, or when the face authentication unit 352 generates an authentication result of face authentication failure.

For example, the multi-step authentication unit 354 displays acceptance of input of encrypted information on the screen display unit 320, and accepts input of encrypted information from an authentication target person using the operation input unit 310 or the like. Further, when accepting the input of encrypted information, the multi-step authentication unit 354 refers to the multi-step authentication information 342 to confirm whether the received encrypted information is stored in the multi-step authentication information 342. In a case where the accepted encrypted information is stored in the multi-step authentication information 342, the multi-step authentication unit 354 generates an authentication result of multi-step authentication success. In a case where encrypted information for each user is stored in the multi-step authentication information 342, the multi-step authentication unit 354 may generate an authentication result of multi-step authentication success and also specify an authentication target person of multi-step authentication. On the other hand, in a case where the accepted encrypted information is not stored in the multi-step authentication information 342, the multi-step authentication unit 354 generates an authentication result of multi-step authentication failure. In a case where the accepted encrypted information is not stored in the multi-step authentication information 342, the multi-step authentication unit 354 may accept re-input of encrypted information until a predetermined number of times is satisfied.

Further, in a case where multi-step authentication is performed by generation of an authentication result of face authentication failure by the face authentication unit 352, in a case where the accepted encrypted information is stored in the multi-step authentication information 342, it is likely that the authentication target person is the user and face authentication failure has occurred. Therefore, the multi-step authentication unit 354 can determine that a false authentication has been performed that is a failure of authentication of an authentication target person whose face image should be stored in the authentication system 100 in the case as described above. In this manner, the multi-step authentication unit 354 can also perform multi-step authentication with the authentication target person, which is a process different from the face authentication, to confirm whether a false authentication has occurred.

The score storing unit 355 stores the score calculated by the face authentication unit 352 into the storage unit 340. The score storing unit 355 can store scores of types corresponding to the results of processing by the respective processing units of the face authentication unit 352, the result confirming unit 353 and the multi-step authentication unit 354, such as a genuine score, a false authentication score including a false acceptance score and a false rejection score, and an imposter score.

For example, in a case where the face authentication unit 352 generates an authentication result of face authentication success and it is confirmed that there is nothing wrong by the result confirming unit 353, the score storing unit 355 can store a genuine score that is a score equal to or more than a threshold value or an imposter score into the storage unit 340. Moreover, in a case where the face authentication unit 352 generates an authentication result of face authentication success and the result confirming unit 353 confirms that the person is different, the score storing unit 355 can store a false acceptance score or an imposter score, instead of a genuine score. In a case where the face authentication unit 352 generates an authentication result of face authentication success and it is confirmed that the person is different by the result confirming unit 353, the score storing unit 355 may store a false acceptance score or an imposter score on the condition of multi-step authentication success by the multi-step authentication unit 354. Moreover, in a case where the face authentication unit 352 generates an authentication result of face authentication failure and the multi-step authentication unit 354 generates an authentication result of multi-step authentication success, the score storing unit 355 can store a false rejection score or an imposter score. In a case where the face authentication unit 352 generates an authentication result of face authentication failure and the multi-step authentication unit 354 generates an authentication result of multi-step authentication failure, the score storing unit 355 may store the score as a score of a person who is not a user of the authentication system 100, or may not store the score.

The score storing unit 355 may store a genuine score, a false authentication score or the like for each user. The identification of the user can be performed by, for example, generation of an authentication result of face authentication success by the face authentication unit 352 and confirmation that there is nothing wrong by the result confirming unit 353, acceptance of input of information for identifying the user by the result confirming unit 353, and identification of the user by multi-step authentication. In addition, the authentication apparatus 300 may identify the user at a timing other than those illustrated above, such as reading an employee ID card at any timing. Moreover, the score storing unit 355 may store the scores for each imaging device 200.

In summary, the authentication process and the score storing process are performed as shown in FIGS. 3 and 4. For example, as shown in FIG. 3, in a case where the face authentication unit 352 generates an authentication result of face authentication success, the confirmation by the result confirming unit 353 is performed. In a case where there is no particular problem as a result of the confirmation by the result confirming unit 353, a genuine score or the like is stored. On the other hand, in a case where it is determined that it is a false authentication as a result of the confirmation by the result confirming unit 353, a false acceptance score or the like is stored. The storing of a false acceptance score may be performed in accordance with the result of multi-step authentication. Moreover, referring to FIG. 4, when the face authentication unit 352 generates an authentication result of face authentication failure, multi-step authentication is performed. In a case where multi-step authentication succeeds, a false rejection score or the like is stored. In a case where multi-step authentication fails, there is no need to store any score.

The threshold value adjustment unit 356 performs an adjustment of a threshold value used when the face authentication unit 353 performs face authentication, based on the result stored by the score storing unit 352. In other words, the threshold value adjustment unit 356 adjusts a threshold value included in the threshold value information 344 based on the distribution of false authentication scores included in the score information 343, and the like. For example, the threshold value adjustment unit 356 can adjust the threshold value for each user based on the distribution of scores for each user. The threshold value adjustment unit 356 may adjust the threshold value in units stored in the score information 343. For example, the threshold value adjustment unit 356 can determine whether or not to adjust the threshold value by confirming whether a false authentication score stored after the abovementioned adjustment is present, at a given interval determined in advance. As an example, the threshold value adjustment unit 356 may determine to perform the adjustment of the threshold value when a false authentication score stored after the previous adjustment is present. The threshold value adjustment unit 356 may determine whether or not to adjust the threshold value by confirming whether a condition other than that illustrated above is satisfied, such as the number of false authentication scores exceeding a predetermined number.

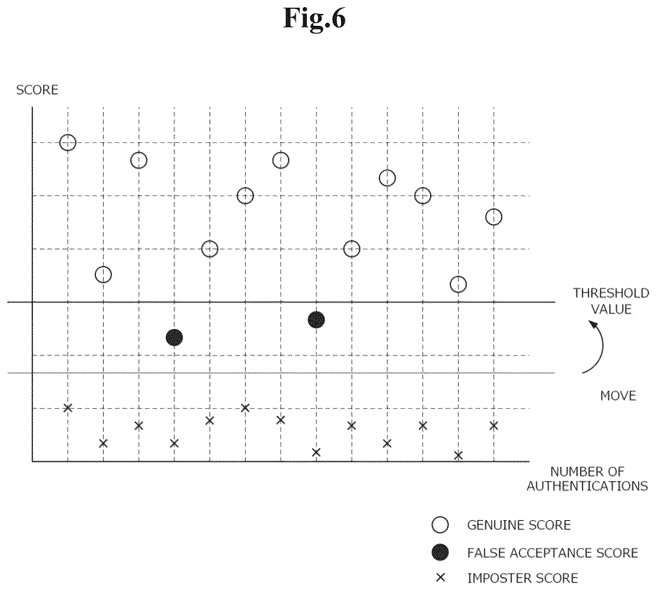

For example, the threshold value adjustment unit 356 performs the adjustment of the threshold value based on the distribution of false authentication scores, genuine scores and so forth in such a manner that false acceptance scores are less than the threshold value as long as possible. FIGS. 5 and 6 illustrate an example of the adjustment by the threshold value adjustment unit 356. For example, in FIGS. 5 and 6, a white circle indicates a genuine score, a black circle indicates a false acceptance score, and a cross mark indicates an imposter score. In the case illustrated in FIG. 5, there is a false acceptance score having a value equal to or more than the threshold value in the stage before threshold value adjustment. Therefore, as shown in FIG. 6, the threshold value adjustment unit 356 performs an adjustment to increase the threshold value in such a manner that the value of the false acceptance score is less than the threshold value as much as possible. In this case, as shown in FIG. 6, the threshold value adjustment unit 356 preferably adjusts the threshold value in such a manner that the value of the genuine score remains equal to or more than the threshold value.

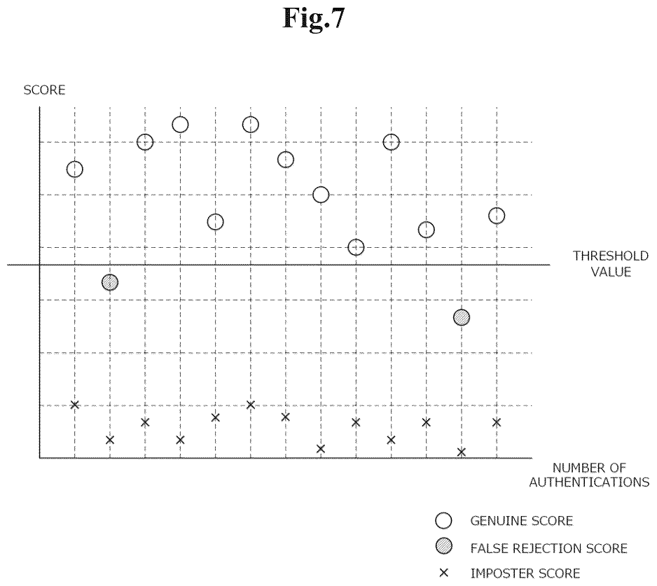

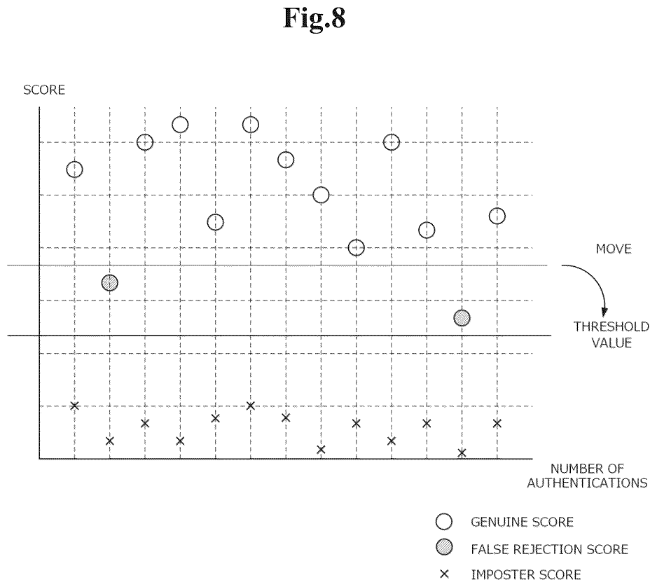

In addition, for example, the threshold value adjustment unit 356 performs the adjustment of the threshold value based on the distribution of false authentication scores, genuine scores, and the like in such a manner that the value of the false rejection score is equal to or more the threshold value as much as possible. For example, in FIGS. 7 and 8, a white circle indicates a genuine score, a slash circle indicates a false acceptance score, and a cross mark indicates an imposter score. As illustrated in FIG. 7, there is a false rejection score having a value less than the threshold value in the stage before threshold value adjustment. Therefore, as shown in FIG. 8, the threshold value adjustment unit 356 performs an adjustment to lower the threshold value in such a manner that the value of the false rejection score is equal to or more than the threshold value as much as possible. In this case, as shown in FIG. 8, the threshold value adjustment unit 356 preferably adjusts the threshold value in such a manner that the value of the imposter score is not equal to or more than the threshold value.

For example, as described above, the threshold value adjustment unit 356 performs the adjustment of the threshold value in such a manner that false authentication is reduced as much as possible based on the distribution of false authentication scores such as a false acceptance score or a false rejection score. In addition, at the time of implementation operation, there is a case where both an imposter rejection score and a false rejection score are included, or there is a case where a genuine score and false authentication scores are mixed. The threshold value adjustment unit 356 may adjust the threshold value using any method in such a manner as to minimize false rejection while removing false acceptance at the maximum by calculating the rate of each of the scores, for example. In addition, the value adjustment unit 356 may have preset information such as whether to perform an adjustment that emphasizes a false acceptance score or a false rejection score, for example. In this case, the threshold value adjustment unit 356 may perform an adjustment according to the set information.

The determining unit 357 determines whether to confirm the result by the result confirming unit 353 based on the adjustment state. For example, the determining unit 357 can perform the above determination by confirming whether a period in which the threshold value adjustment by the threshold value adjustment unit 356 is not performed satisfies a predetermined condition.

For example, in a case where a period in which the threshold value adjustment by the threshold value adjustment unit 356 is not performed satisfies a predetermined condition such as a given one, the determining unit 357 determines to omit without confirmation of the result by the result confirming unit 353. On the other hand, in a case where the condition is not satisfied, the determining unit 357 determines to perform without omitting confirmation of the result by the result confirming unit 353. In this case, the confirmation of the result by the result confirming unit 353 is performed.

Any condition may be set as the condition used by the determining unit 357 in making the determination. For example, the condition may be that the threshold value has not been adjusted for a predetermined period, or that the number of times of adjustment within a predetermined period is less than a certain value. Any period and any number of times may be set as the period and the number of times of adjustment that the adjustment has not been performed.

The above is an example of the configuration of the authentication apparatus 300. The authentication apparatus 300 may have a configuration other than the configuration illustrated in FIG. 2. For example, the authentication apparatus 300 may have an output unit that outputs information stored in the storage unit 340, such as the score information as illustrated in FIGS. 5 to 8 to an external device or the like.

Subsequently, an example of operation of the authentication apparatus 300 will be described with reference to FIGS. 9 to 11. FIG. 9 is a flowchart showing an example of operation at the time of score storage. Referring to FIG. 9, the face authentication unit 352 performs a face authentication process to confirm whether a face image of a person matching a person in a face image acquired by the imaging device 200 is stored in the storage unit 340 based on the facial feature information 341 and the threshold value information 344 (step S101).

In a case where the face authentication unit 352 generates an authentication result of face authentication success (step S102, Yes), the result confirming unit 353 confirms with an authentication target person whether there is an error in the authentication by the face authentication unit 352 (step S103). In a case where it can be confirmed that there is nothing wrong based on the confirmation by the result confirming unit 353 (step S104, Yes), the result confirming unit 353 can determine to omit multi-step authentication. In this case, the score storing unit 355 stores a genuine score or the like into the storage unit 340 (step S105). On the other hand, in a case where it is confirmed that the authentication target person is different from the identified user based on the confirmation by the result confirming unit 353 (step S104, No), the result confirming unit 353 determines that a false authentication based on another person's face image has been performed. In this case, the score storing unit 355 stores a false acceptance score or the like (step S106). Further, multi-step authentication is performed by the multi-step authentication unit 354 (step S107). The storing of the false acceptance score may be performed in accordance with the result of the multi-step authentication by the multi-step authentication unit 354.

Moreover, in a case where the face authentication unit 352 generates an authentication result of face authentication failure (step S102, No), the multi-step authentication unit 354 performs multi-step authentication (step S108). In a case where the multi-step authentication unit 354 generates an authentication result of multi-step authentication success (step S109, Yes), it is highly possible that the authentication target person is the user and face authentication failure has occurred. Therefore, the multi-step authentication unit 354 determines that a false authentication has been performed that is a failure in authentication of the user whose face image should be stored in the authentication system 100. In this case, the score storing unit 355 stores a false rejection score or the like into the storage unit 340 (step S110). On the other hand, in a case where the multi-step authentication unit 354 generates an authentication result of multi-step authentication failure (step S109, No), for example, the authentication apparatus 300 terminates the process.

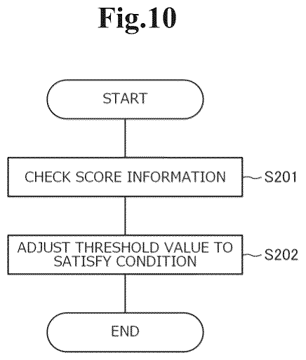

The above is an example of the operation at the time of score storage. Subsequently, an example of operation at the time of threshold value adjustment will be described with reference to FIG. 10.

FIG. 10 shows an example of the operation of the authentication apparatus 300 at the time of threshold value adjustment. The operation shown in FIG. 10 may be performed periodically at a given interval determined in advance, or may be performed when a predetermined condition is satisfied, such as when the number of newly stored false authentication scores exceeds a given value.

Referring to FIG. 10, the threshold value adjustment unit 356 checks the score information 343 to determine whether or not to perform the threshold value adjustment (step S201).

In the case of performing the threshold value adjustment, the threshold value adjustment unit 356 adjusts a threshold value that is a value used when the face authentication unit 352 performs face authentication, based on the result stored by the score storing unit 355 (step S202). For example, the threshold value adjustment unit 356 performs the threshold value adjustment in such a manner that false authentication is reduced as much as possible, based on false authentication scores such as a false acceptance score and a false rejection score. In other words, the threshold value adjustment unit 356 adjusts the threshold value in such a manner as to minimize false rejection while avoiding false acceptance at the maximum.

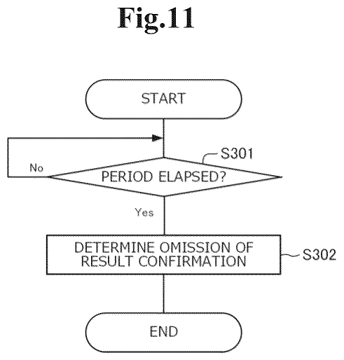

The above is an example of the operation at the time of threshold value adjustment. Subsequently, an example of operation at the time of determining whether or not to perform result confirmation by the result confirming unit 353 will be described with reference to FIG. 11.

FIG. 11 is a flowchart showing an example of operation at the time of determining whether or not to perform result confirmation by the result confirming unit 353. Referring to FIG. 11, the determining unit 357 confirms whether a period in which the threshold value adjustment by the threshold value adjustment unit 356 is not performed satisfies a given condition (step S301).

In a case where a period in which the threshold value adjustment by the threshold value adjustment unit 356 is not performed satisfies a predetermined condition such as a given period or more (step S301, Yes), the determining unit 357 determines to omit without performing result confirmation by the result confirming unit 353 (step S302). On the other hand, in a case where the condition is not satisfied (step S301, No), the determining unit 357 determines to perform without omitting result confirmation by the result confirming unit 353. In this case, the result confirmation by the result confirming unit 353 is performed.

The above is an example of the operation at the time of determining whether or not to perform result confirmation by the result confirming unit 353.

Thus, the authentication apparatus 300 includes the score storing unit 355 and the threshold value adjustment unit 356. According to such a configuration, the threshold value adjustment unit 356 can perform the threshold value adjustment based on the false authentication scores and so forth stored by the score storing unit 355. As a result, it is possible to properly adjust the threshold value in such a manner as to reduce the possibility of false authentication as much as possible. Moreover, the score storing unit 355 is configured to store the score for each user. According to this, the threshold value adjustment unit 356 can adjust the threshold value for each user. As a result, it is possible to more properly adjust the threshold value.

Further, the authentication apparatus 300 includes the result confirming unit 353 and the multi-step authentication unit 354. According to such a configuration, the score storing unit 355 can store the false authentication score into the storage unit 340 when it is determined that there is a possibility of false authentication as a result of processing by the result confirming unit 353 or the multi-step authentication unit 354. As a result, the threshold value adjustment unit 356 can perform a more proper adjustment of the threshold value based on the false authentication score and so forth stored by the score storing unit 355.

Further, the authentication apparatus 300 includes the determining unit 357. According to such a configuration, the determining unit 357 can determine to omit the confirmation by the result confirming unit 353 when a given condition is satisfied. As a result, the result confirmation can be omitted when it can be determined that the threshold value has been adjusted to a proper value.

In addition, the configurations of the imaging device 200 and the authentication apparatus 300 may be other than those illustrated in this example embodiment. For example, the imaging device 200 may have at least part of the configuration of the authentication apparatus 300 illustrated in this example embodiment. Likewise, the authentication apparatus 300 may have a function as the imaging device 200.

### Second Example Embodiment

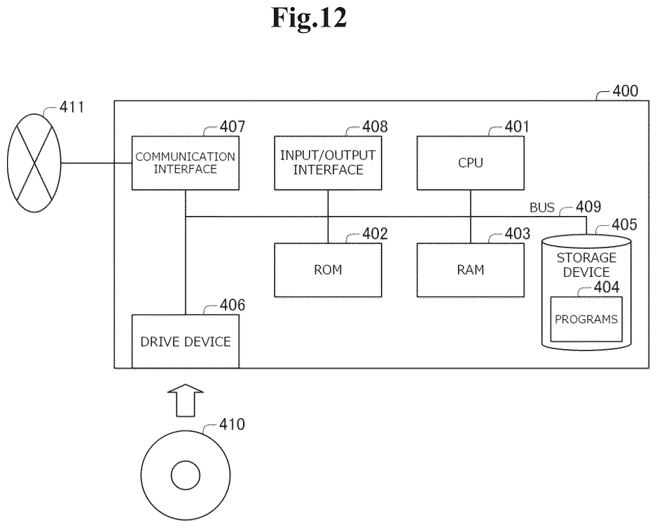

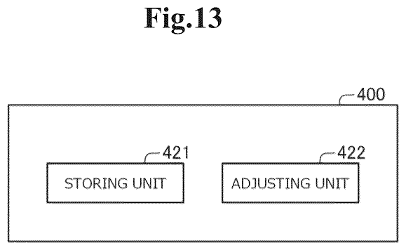

Next, a second example embodiment of the present disclosure will be described with reference to FIGS. 12 and 13. In the second example embodiment of the present disclosure, the overview of a configuration of a processing apparatus 400 that is an information processing apparatus will be described.

FIG. 12 shows an example of the hardware configuration of the processing apparatus 400. Referring to FIG. 12, the processing apparatus 400 has, as an example, the following hardware configuration including:
a CPU (Central Processing Unit) 401 (arithmetic logic unit);
a ROM (Read Only Memory) 402 (memory unit);
a RAM (Random Access Memory) 403 (memory unit);
programs 404 loaded into the RAM 403;
a storage device 405 storing the programs 404;
a drive device 406 that performs reading from and writing into a recording medium 410 external to the information processing apparatus;
a communication interface 407 connected to a communication network 411 external to the information processing apparatus;
an input/output interface 408 that performs input/output of data; and
a bus 409 connecting the components.

Further, the processing apparatus 400 can realize functions as a storing unit 421 and an adjusting unit 422 shown in FIG. 13 by acquisition and execution of the programs 404 by the CPU 401. The programs 404 are, for example, stored in advance in the storage device 405 or the ROM 402, and are loaded into the RAM 403 or the like and executed by the CPU 401 as necessary. Moreover, the programs 404 may be provided to the CPU 401 via the communication network 411, or the programs may be stored in advance in the recording medium 410 and read out by the drive device 406 and provided to the CPU 401.

FIG. 12 shows an example of the hardware configuration of the processing apparatus 400. The hardware configuration of the processing apparatus 400 is not limited to the abovementioned case. For example, the processing apparatus 400 may include part of the abovementioned configuration, such as not having the drive device 406.

The storing unit 421 stores a false authentication score, which is a score calculated when it is determined that a false authentication has occurred in the face authentication, into the memory unit.

The adjusting unit 422 adjusts a value used at the time of face authentication based on the false authentication score.

Thus, the processing apparatus 400 includes the storing unit 421 and the adjusting unit 422. According to such a configuration, the adjusting unit 422 can adjust a value used at the time of face authentication based on the false authentication score. As a result, it is possible to perform a proper adjustment.

The information processing apparatus such as the processing apparatus 400 described above can be realized by incorporating a given program into the information processing apparatus. To be specific, a program as another aspect of the present invention is a program for causing an information processing apparatus to realize processes to store a false authentication score, which is a score calculated when it is determined that a false authentication has occurred in face authentication, into the memory unit, and adjust a value used at the time of performing face authentication based on the false authentication score.

Further, a processing method performed by the information processing apparatus described above includes, by the information processing apparatus, storing a false authentication score, which is a score calculated when it is determined that a false authentication has occurred in face authentication, into the memory unit, and adjusting a value used at the time of face authentication based on the false authentication score.

Even if the invention of a program (or a recording medium) or a processing method has the above configuration, the object of the present invention described above can be achieved because the same action and effect as in the case described above are achieved.

### SUPPLEMENTARY NOTES

The whole or part of the example embodiments disclosed above can be described as the following supplementary notes. Hereinafter, the overview of the processing apparatus and so forth in the present invention will be described. However, the present invention is not limited to the following configurations.

### Supplementary Note 1

A processing apparatus comprising:
a storing unit that stores a false authentication score, which is a score calculated when it is determined that false authentication has occurred in face authentication, into a storage device; and
an adjusting unit that adjusts a value used when face authentication is performed based on the false authentication score.

### Supplementary Note 2

The processing apparatus according to supplementary note 1, further comprising
a confirming unit that confirms whether false authentication has occurred by performing confirmation different from face authentication on an authentication target person in face authentication,
wherein the storing unit stores the false authentication score in accordance with a result of the confirmation by the confirming unit.

### Supplementary Note 3

The processing apparatus according to supplementary note 2, wherein:
the confirming unit confirms whether false authentication has occurred by confirming whether a person identified by face authentication is the authentication target person; and
the storing unit stores the false authentication score in accordance with the result of the confirmation by the confirming unit.

### Supplementary Note 4

The processing apparatus according to supplementary note 3, wherein:
the storing unit stores a false acceptance score, which is a score calculated when false authentication based on a face image of another person has been performed, as the false authentication score; and
the adjusting unit adjusts a threshold value used when face authentication is performed based on the false acceptance score.

### Supplementary Note 5

The processing apparatus according to supplementary note 3, wherein
the confirming unit confirms whether the person identified by face authentication is the authentication target person when it is determined that authentication is successful in face authentication.

### Supplementary Note 6

The processing apparatus according to supplementary note 3, further comprising
a determining unit that determines whether to perform the confirmation by the confirming unit based on a given condition determined in advance,
wherein the confirming unit performs the confirmation in accordance with a result of the determination by the determining unit.

### Supplementary Note 7

The processing apparatus according to supplementary note 2, wherein:
the confirming unit confirms whether false authentication has occurred by accepting input of predetermined encrypted information from the authentication target person; and
the storing unit stores the false authentication score in accordance with the result of the confirmation by the confirmation unit.

### Supplementary Note 8

The processing apparatus according to supplementary note 7, wherein:
the storing unit stores a false rejection score, which is a score calculated when it is determined that authentication of a person who should be authenticated is a failure, as the false authentication score; and
the adjusting unit adjusts a threshold value used when face authentication is performed based on the false rejection score.

### Supplementary Note 9

A processing method by an information processing apparatus, the processing method comprising:
storing a false authentication score, which is a score calculated when it is determined that false authentication has occurred in face authentication, into a storage device; and
adjusting a value used when face authentication is performed based on the false authentication score.

### Supplementary Note 10

A non-transitory computer-readable recording medium having a program recorded thereon, the program comprising instructions for causing an information processing apparatus to realize processes to:
store a false authentication score, which is a score calculated when it is determined that false authentication has occurred in face authentication, into a storage device; and
adjust a value used when face authentication is performed based on the false authentication score.

The programs described in the above example embodiments and supplementary notes may be stored in a storage device, or the programs may be recorded in a computer-readable recording medium. For example, the recording medium is a portable medium such as flexible disk, optical disk, magneto-optical disk, and semiconductor memory.

Although the present invention has been described above with reference to the above example embodiments, the present invention is not limited to the example embodiments described above. The configuration and details of the present invention can be changed in various manners that can be understood by those skilled in the art within the scope of the present invention.

The present invention is based upon and claims the benefit of priority from Japanese patent application No. 2022-161038, filed on Oct. 5, 2022, the disclosure of which is incorporated herein in its entirety by reference.

### REFERENCE SIGNS LIST

100 authentication system
200 imaging device
300 authentication apparatus
310 operation input unit
320 screen display unit
330 communication I/F unit
340 storage unit
341 facial feature information
342 multi-step authentication information
343 score Information
344 threshold value Information
345 program
350 arithmetic processing unit
351 face image acquiring unit
352 face authentication unit
353 result confirming unit
354 multi-step authentication unit
355 score storing unit
356 threshold value adjustment unit
357 determining unit
400 processing apparatus
401 CPU (Central Processing Unit)
402 ROM
403 RAM
404 programs
405 storage device
406 drive device
407 communication interface
408 input/output interface
409 bus
410 recording medium
411 communication network
421 storing unit
422 adjusting unit

What is claimed is:

1. A processing apparatus comprising:
at least one memory storing processing instructions; and
at least one processor configured to execute the processing instructions to:
store a false authentication score, which is a score calculated when it is determined that false authentication has occurred in face authentication, into a storage device; and
adjust a value used when face authentication is performed based on the false authentication score.

2. The processing apparatus according to claim 1, wherein the at least one processor is configured to execute the processing instructions to:
confirm whether false authentication has occurred by performing confirmation different from face authentication on an authentication target person in face authentication; and
store the false authentication score in accordance with a result of the confirmation by the confirming unit.

3. The processing apparatus according to claim 2, wherein the at least one processor is configured to execute the processing instructions to:
confirm whether false authentication has occurred by confirming whether a person identified by face authentication is the authentication target person; and
store the false authentication score in accordance with the result of the confirmation by the confirming unit.

4. The processing apparatus according to claim 3, wherein the at least one processor is configured to execute the processing instructions to:
store a false acceptance score, which is a score calculated when false authentication based on a face image of another person has been performed, as the false authentication score; and
adjust a threshold value used when face authentication is performed based on the false acceptance score.

5. The processing apparatus according to claim 3, wherein the at least one processor is configured to execute the processing instructions to
confirm whether the person identified by face authentication is the authentication target person when it is determined that authentication is successful in face authentication.

6. The processing apparatus according to claim 3, wherein the at least one processor is configured to execute the processing instructions to:
determine whether to perform the confirmation by the confirming unit based on a given condition determined in advance; and
perform the confirmation in accordance with a result of the determination by the determining unit.

7. The processing apparatus according to claim 2, wherein the at least one processor is configured to execute the processing instructions to:
confirm whether false authentication has occurred by accepting input of predetermined encrypted information from the authentication target person; and
store the false authentication score in accordance with the result of the confirmation by the confirmation unit.

8. The processing apparatus according to claim 7, wherein the at least one processor is configured to execute the processing instructions to:
store a false rejection score, which is a score calculated when it is determined that authentication of a person who should be authenticated is a failure, as the false authentication score; and
adjust a threshold value used when face authentication is performed based on the false rejection score.

9. A processing method by an information processing apparatus, the processing method comprising:
storing a false authentication score, which is a score calculated when it is determined that false authentication has occurred in face authentication, into a storage device; and
adjusting a value used when face authentication is performed based on the false authentication score.

10. A non-transitory computer-readable recording medium having a program recorded thereon, the program comprising instructions for causing an information processing apparatus to realize processes to:
store a false authentication score, which is a score calculated when it is determined that false authentication has occurred in face authentication, into a storage device; and
adjust a value used when face authentication is performed based on the false authentication score.
